(19) United States
(12) Patent Application Publication
(10) Pub. No.: US 2018/0169875 A1
(43) Pub. Date: Jun. 21, 2018

(54) FOLDING TOOL WITH ADJUSTABLE LINER LOCK

(71) Applicant: Benchmade Knife Co., Inc., Oregon City, OR (US)

(72) Inventor: Brian Valdez, Oregon City, OR (US)

(21) Appl. No.: 15/737,244

(22) PCT Filed: Sep. 27, 2016
(86) PCT No.: PCT/US16/53872

§ 371 Date: Dec. 15, 2017

Related U.S. Application Data
(60) Provisional application No. 62/239,302, filed on Oct. 9, 2015.

(51) Int. Cl. B26B 1/04; B25G 3/32

(52) U.S. Cl. CPC B26B 1/044; B25G 3/32

(57) ABSTRACT

A hand tool such as a folding knife with a liner lock that incorporates a mechanism that allows for variance in and adjustment of the blade lockup position. The adjustment mechanism is defined by a rotatable lockface head having plural surfaces, each having a diametrical distance from an axial centerline that is different from adjacent surfaces. Rotation of the lockface head allows for adjustment of the lockup position of the blade.

### FIELD OF THE INVENTION

This invention relates to hand tools such as knives and multitools that incorporate folding implements and which include a liner lock, and more specifically to such a folding tool in which the liner lock includes an adjustment mechanism that allows adjustment of the implement lock up position.

### BACKGROUND

Many types of hand tools such as knives and multitools incorporate folding mechanisms that allow an implement to be moved between a folded position in which the implement is safely stowed in the tool handle, and an extended position in which the implement is ready for work. One typical example of such a folding tool is a knife having a folding blade. The knife handle typically has two opposed handle portions defining a blade-receiving groove. A blade pivots on a shaft attached to the handle such that in a folded position the blade is stowed with the cutting portion of the blade safely in the groove, and such that in an extended position the blade is extended away from the handle, ready for use. Foldable knifes are ubiquitous.

To increase the safety of folding tools such as knives, many such tools incorporate locking mechanisms of one type or another. When the knife blade pivots into the open position, its pivotal movement is stopped with a transverse blade stop pin housed in the handle. Often a locking mechanism is included that prevents the blade from pivoting back from the open into the closed position. There are many types of locking mechanisms. One common type is a “liner lock.” This kind of mechanism relies upon a resilient lever formed as part of a handle liner or the handle scale. When the blade is pivoted to the open or extended position, a forward lock face on the resilient lever engages a cooperatively formed ramp on the tang portion of the blade and thereby locks the blade in the open position.

Most folding knives, including those that use liner locks, are manufactured according to strict manufacturing tolerances. Often these tolerances mandate that there are cumulatively only a few thousandths of an inch tolerance in the assembled product. This means that when manufacturing the numerous parts for a knife, each part has to be within even smaller tolerances for the finished product to meet cumulative specifications. Unfortunately, manufacturing tolerances are not always easily controlled. In a folding knife, out-of-tolerance or near tolerance parts can add up in the finished product and result in an assembled product that does not meet final quality specifications and does not operate properly.

In the example of a folding knife that uses a stop pin and a locking mechanism, if the assembled product is out of specification, the locking mechanism may not engage properly. To remedy this situation, the unit must be repaired to adjust the locking mechanism so it works properly and to bring it within acceptable specifications. With liner lock knives this requires that the knife is disassembled and one or more parts replaced or repaired by milling to bring the part or the assembled product within acceptable specification ranges. For example, with a liner lock the liner lever may need to be milled, or the ramp portion of the blade may be milled, or the liner may need to be replaced. The stop pin may also be milled. But regardless of the process that is used to adjust the blade locking mechanism, disassembly, milling and repair and reassembly are time consuming and expensive. Furthermore, normal use of the knife with multiple opening/closing cycles can lead to wear on the lock face of the liner lock where lock face abuts the tang of the blade. This normal wear can lead to an out-of-tolerance condition. While the wear may be only thousandths of inches, it can be enough to loosen the integrity of the lock up position and thus compromise the integrity and safety of the tool.

One unique and highly effective solution to the problem just described—in fact, patented solution—is described in U.S. Pat. No. 7,278,213, which is owned by the owner of the present application. In the '213 patent the knife utilizes a conventional liner lock and the blade stop pin defines a multifaceted face having plural surfaces, each having a radial distance from an axial centerline that is different from adjacent surfaces. Axial rotation of the stop pin is effective to change the diameter of the stop pin and therefore allows for adjustment of the stop position of the blade. The invention described in the '213 patent has been highly commercially successful.

In addition to the issues mentioned above, it is increasingly popular to incorporate bearings in folding tools such as knives that reduce friction between the handle and the blade when the blade moves relative to the handle. For example, there are more and more knives being manufactured that utilize cartridge bearings that encircle the blade pivot pin. While these types of bearings are functionally beneficial to the extent that they reduce rotational friction on the blade, they tend to occupy more real estate, so to speak, within the knife handle. Since many knives include numerous and complex internal mechanical components such as automatic or semi-automatic drive mechanism, the extra space required by bearings may force the knife designer to accommodate the loss of space with changes to the other components.

These combined factors—variable manufacturing tolerances, wear on the lockface of a liner lock, and the needs for economy of part size—contribute to a need for an apparatus that allows adjustment of the implement lockup position in a folding tool that incorporates a liner lock.

The present invention relates to a hand tool handle that incorporates a mechanism for variably adjustment of the lockup position of the implement when it is in the open position.

There is a need, therefore for innovations in the technology involved in locking a blade in the open position in a tool that uses a liner lock. The present invention brings the following advantages and advancements to the technology:
Ability to account for manufacturing tolerances;
Ease of assembly;
Ability to tailor lockface material choice to suit lockup needs for different blade materials;
Ability to adjust for wear between the lockup surfaces caused by repeated opening and closing cycles;
Ability to have a replaceable lockface;
It may be used as a lock bar stabilizer which prevents the lock bar from being pulled past the outside of the handle;
Aesthetically it helps reduce the amount of screws around the front of the knife thus, providing a cleaner appearance.
Allows for adjustability of mechanism without affecting rotational position of the blade with respect to the handle. This not only preserves the aesthetics of the knife, but also provides more consistent lock up geometry.

### BRIEF DESCRIPTION OF THE DRAWINGS

The invention will be better understood and its numerous objects and advantages will be apparent by reference to the following detailed description of the invention when taken in conjunction with the following drawings.

FIG. 1 is a side elevation view of a hand tool—in this case a folding knife—that is exemplary of the type of hand tool that incorporates a liner lock that includes an adjustment mechanism in accordance with the illustrated invention. In FIG. 1 the knife blade is shown in the open position and the near-side handle components have been removed to illustrate the internal structures of the present invention.

FIG. 1A is a top plan view of a folding knife according to the present invention that incorporates a liner lock and wherein the knife is shown in a fully assembled condition.

FIG. 2 is a perspective, partially fragmentary and close up view of the knife shown in FIG. 1 with the blade in the open position and illustrating the lockup adjustment mechanism according to the invention.

FIG. 3 is a close up, fragmentary and side cross sectional view through knife shown in FIG. 1 and more specifically, through the knife handle, the liner lock lever and lockup mechanism and the blade; in FIG. 3A the spring arm that defines the liner lock is shown in an unlocked position—the liner lock is not engaging and not locking the blade.

FIG. 3A is a is a close up, fragmentary and side cross sectional view of the same components shown in FIG. 3A except the spring arm that defines the liner lock is shown in a locked position—the liner lockup mechanism is engaging and locking the blade in the open position.

FIG. 4 is a top plan view of the adjustment mechanism according to the present invention—the lockface head—and a side elevation view of the same.

FIG. 5 is a series of views of the adjustment mechanism according to the present invention juxtaposed adjacent one another and illustrating exemplary dimensions.

FIG. 6 is a schematic view of a lockface head according to the present invention in which the various reference dimensions are illustrated.

### DETAILED DESCRIPTION OF ILLUSTRATED EMBODIMENTS

The invention will now be described in detail with reference to the drawings.

A preferred embodiment of a hand tool 10 incorporating a liner lock adjustment mechanism in accordance with the illustrated invention is shown in the figures. Although the invention is described with respect to a particular type of tool—a knife—it will be appreciated that references to this type of a knife, and indeed this particular type of hand tool, are for illustrative purposes to describe the invention. Those of ordinary skill in the art will appreciate that the invention claimed herein is not limited to knives, but instead extends to any hand tool having the features claimed herein.

Generally, hand tool 10 is defined by an elongate handle 12 and a blade 14 that is pivotally attached to the handle at the “forward” end of handle 12. The opposite end of handle 12 is referred to as rearward or butt end. Other relative directional terms used in this description correspond to this convention: the “rear” or butt end of the handle is opposite the forward end; the “upper” part of the blade is the dull, non-working portion and the “lower” part of the blade is the sharpened, working portion; “inner” or “inward” refers to the structural center of the knife, and so on.

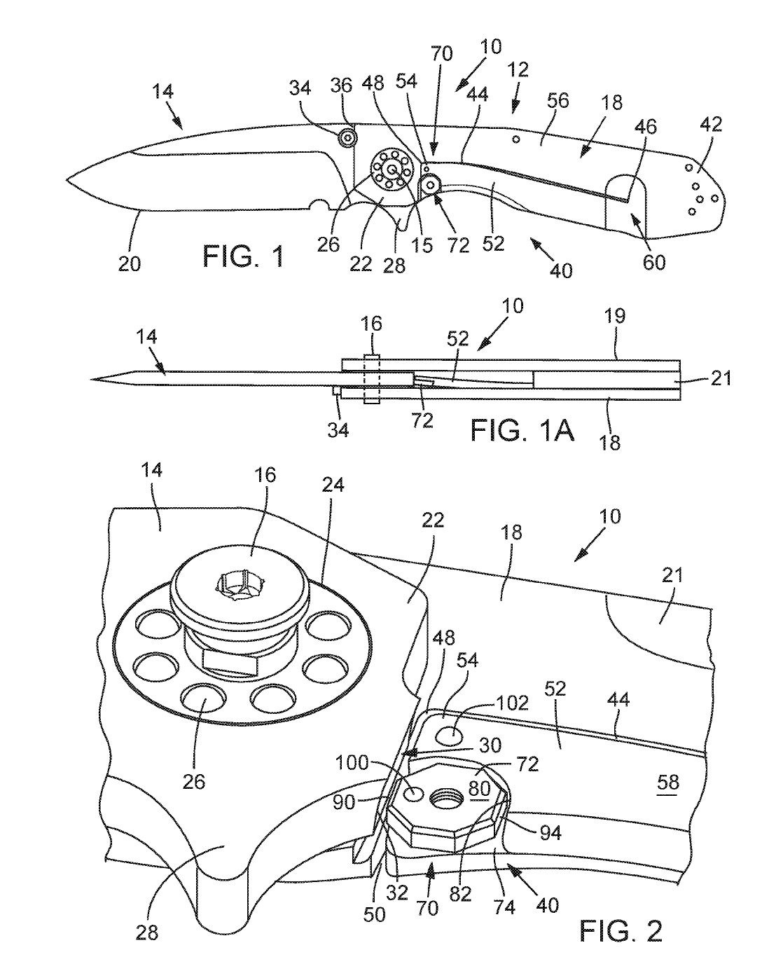

In the figures filed herewith (with the exception of FIG. 1A) the knife 10 is illustrated with the near-side handle half removed in order to illustrate the inventive adjustment mechanism. Nonetheless, an assembled knife 10 that includes both handle halves will be described initially in order to provide background information and context. With particular reference now to FIG. 1, knife 10 includes a handle 12 with a blade 14 pivotally attached to one end of the handle at a blade pivot shaft 16. Handle 12 comprises two primary structural components, a first handle half or side wall 18, a second handle half or side wall 19 (FIG. 1A), and a spacer 21 that separates the two handle halves when the knife is assembled in order to hold the handle halves in a spaced apart orientation to define a blade-receiving groove or slot between the halves. The spacer 21 may be an integral part of the either one of the handle halves 18 or 19, or a separate piece, in either case, defining a spline. When the blade is in the closed position, the working portion 20 of blade 14 is safely stowed in the slot between the handle halves. Blade 14 is pivotally movable about pivot shaft 16 between the fully closed position (not shown) and the fully open position (e.g., FIG. 1).

Knife 10 is in many respects constructed as a conventional knife with a liner locking mechanism. Described generally, the blade 14 of knife 10 includes a tang 22 having a bore 24 through which pivot shaft 16 extends. Specifically, pivot shaft 16 comprises a cylindrical shaft that fits into bore 24 and which interconnects the two handle halves in a conventional manner. The knife 10 illustrated herein utilizes cartridge bearings 26 around the pivot shaft 16 but it will be understood that the invention described herein may be used in knives that do not use bearings with the blade. Blade 14 preferably includes a flipper extension 28 to assist the user with opening and closing the blade.

As seen best in FIG. 2, the rearward end of tang 22 is formed into a face 30, which as detailed below cooperates with the liner lock arm to lock the blade in the open position. The rearward-facing surface of face 30 defines a slightly curved and surface 32 to improve the engagement between the face 30 and the liner lock mechanism when the blade is in the open and locked position.

The handle halves are interconnected in the assembled knife 10 in a conventional manner with fasteners such as screws. A thumb lug 34 is attached to blade 14 and extends from the blade on both sides thereof. When the blade is in the open position, the thumb lug abuts a cooperatively formed notch 36 in the forward end of handle 12; and the thumb lug 34, when it abuts the handle 12 (i.e., in notch 36) thus defines a blade stop that stops rotation of the blade in a fixed position when the blade is in the open position.

The blade locking mechanism, identified generally with reference number 40, will now be described in detail. Handle half 18 is preferably made of a resilient material such as a variety metals and alloys. Handle half 18 comprises an integrally formed, bifurcated sheet comprising a base 42 having an elongate, L-shaped slot 44 extending from the beginning of the slot 44 at a point designated at 46 and extending in a forward direction and turning at a 90° angle at 48 and extending through the edge of the handle half at exit point 50. The elongate slot 44 defines a spring arm 52 having a free end 54 at the forward end of the spring arm and which is an integral part of the handle half 18. The handle half 18 further comprises an elongate fixed body portion 56 opposite of slot 44 from spring arm 52. The inner-facing surface of spring arm 52—that is, the surface of the spring arm that faces the blade-slot—is identified as surface 58.

It will be appreciated that handle half 18 is preferably a one-piece unit and that during fabrication of handle half 18, spring arm 54 is pre-stressed so that the spring arm is given an initial bias inwardly in the direction toward the blade-receiving slot—that is, generally out of the plane of the paper in FIGS. 1 and 2. In some instances the resiliency of the spring arm may be enhanced by forming relatively thinner wall section shown generally at 60 in the handle half near the beginning of slot 44 at point 46 to aid in facilitating the initial inward bias, but this should be seen as optional. The inward bias is preferably sufficiently strong that the free end 54 of spring arm 52 will normally continue to be biased under spring pressure inwardly in the direction toward the blade-receiving slot until constrained against further movement by another structural component of the knife.

With reference to FIG. 1, blade 14 is shown in the open position. In this position, the free end 54 of spring arm 52—that is, the forwardmost end of the spring arm 52—has snapped behind the face 30 of tang 22 and thumb lug 34 is abutting notch 36. The spring force applied to spring arm 52 maintains the spring arm in this locking position, wherein the blade cannot be rotated from the open to the closed position because the free end 54 of the spring arm 52 is in an abutting relationship with the face 30 of tang 22.

With returning reference to FIG. 2, liner locking mechanism 40 of knife 10 includes an adjustment mechanism, which is identified generally with reference number 70. As detailed herein, adjustment mechanism 70 is operable to allow adjustment of the lock up position of blade 14 in knife 10.

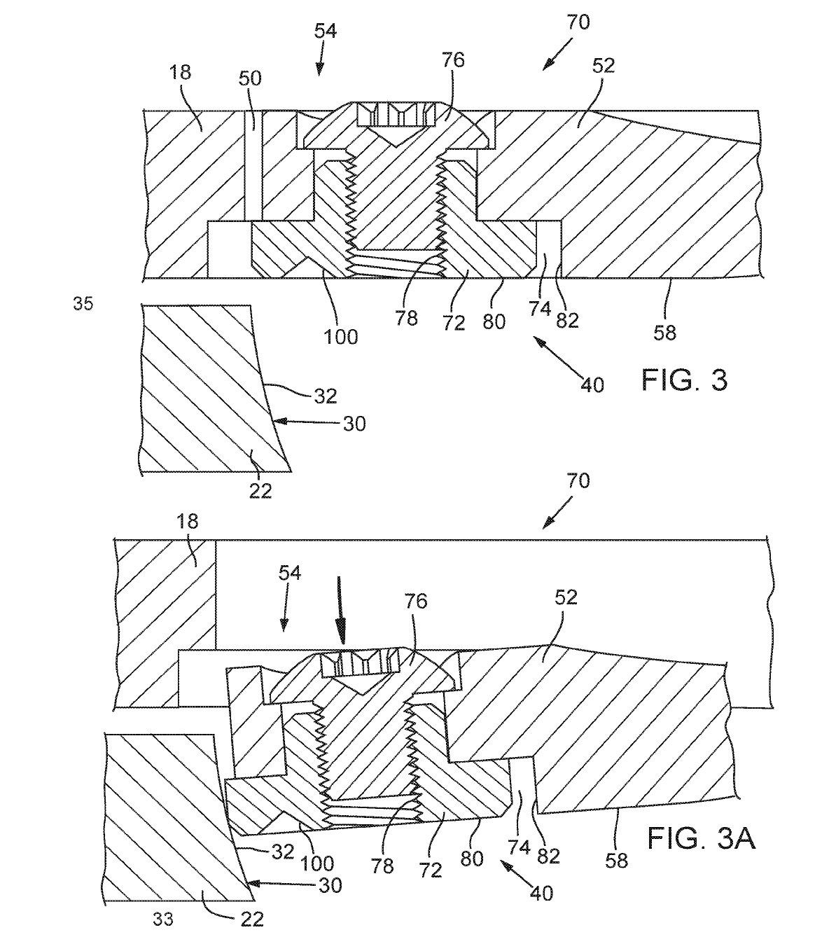

Adjustment mechanism 70 is defined by an adjustable lock member or lockface head 72 that is attached to spring arm 52 at its free end 54 in a recessed cavity 74. As seen in FIG. 3, lockface head 72 is attached to spring arm 52 in cavity 74 with a screw 76 that threads into an internally threaded bore 78 formed in lockface head 72. The thickness of lockface head 72 is nominally the same as the depth of cavity 74 so that the inner-facing surface 80 of lockface head 72 is flush and coplanar with the inner facing surface 58 of spring arm 52. In the embodiment illustrated herein and as described in detail below, the lockface head 72 is octagon in shaped with eight adjacent linear, flat sides. A forward edge of cavity 74 defines a wall 82. When lockface head 72 is attached to spring arm 52 in cavity 74 with screw 76 it is rotated to the desired position relative to the spring arm and is allowed to settle so that a desired face of the lockface is parallel to the blade lock face 30. The lockface head is secured in this desired position by tightening screw 76, which as noted is inserted through a bore in the spring arm and into the threaded bore78 in the lockface head (see FIG. 3). As detailed below, the screw 76 may be loosened so that the lockface head 72 may be rotated to change the lockup position of the blade 14. It will be appreciated that rotation of the lockface head changes the distance from the axial center of the lockface head to the surface that is presented to the blade lock face 30. In addition to the ability to fix the position of lockface head 72 in the spring arm with screw 76, anti-rotation features also may be incorporated.

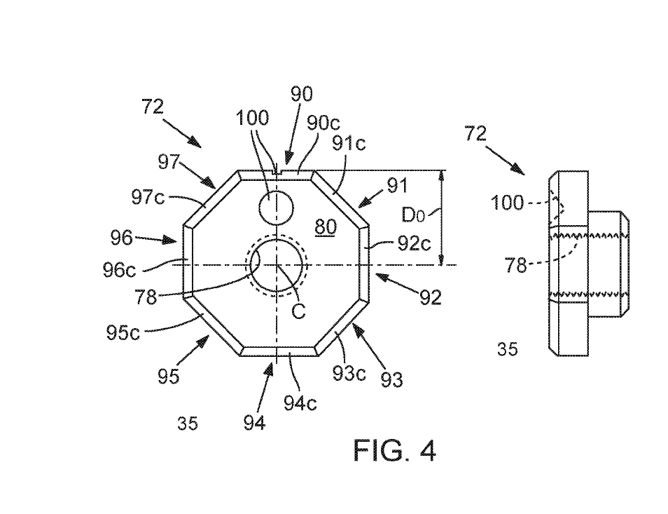

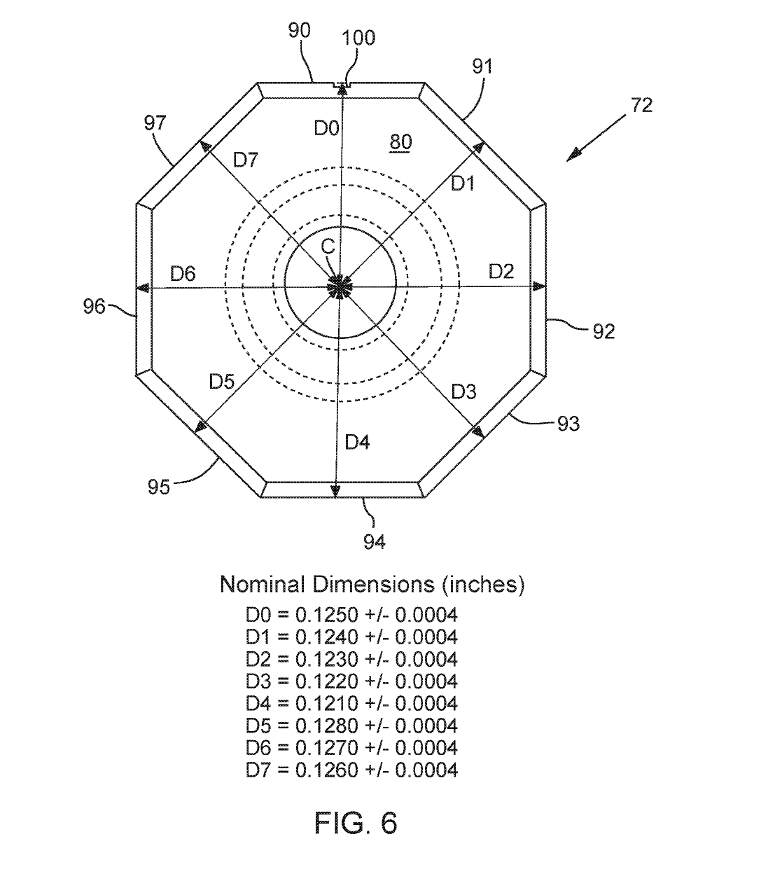

Lockface head 72 will now be described in detail with particular reference to FIGS. 4, 5 and 6. Lockface head 72 may be generally described as a structure that is similar to an octagonal nut, at least insofar as the lockface head has 8 planar surfaces around its periphery. Those surfaces are identified in the figures with numbers 90, 91, 92, 93, 94, 95, 96, and 97 beginning with surface 90 being the surface in the 12:00 o'clock position in the orientation shown in FIG. 4. The diameter of lockface head 72 measured from the axial center point C to the outer surfaces 90-97 of the lockface head is incrementally stepped from one adjacent surface to the next such that the diametrical distance increases incrementally from surface 94, which defines the shortest diameter, and moving in the anticlockwise direction, to surface 95, which defines the greatest diameter. Thus, the diameter measured from C to surface 90 is represented by dimension D₀. The diameter measured from C to surface 91 is represented by dimension D₁. The diameter measured from C to surface 92 is represented by dimension D₂, and so on. As noted, the diametrical distance increases incrementally from one adjacent surface to the next (or decreases depending on the direction of movement around the lockface head). As such, the diametrical distance D₄<D₃<D₂<D₁<D₀<D₇<D₆<D₅.

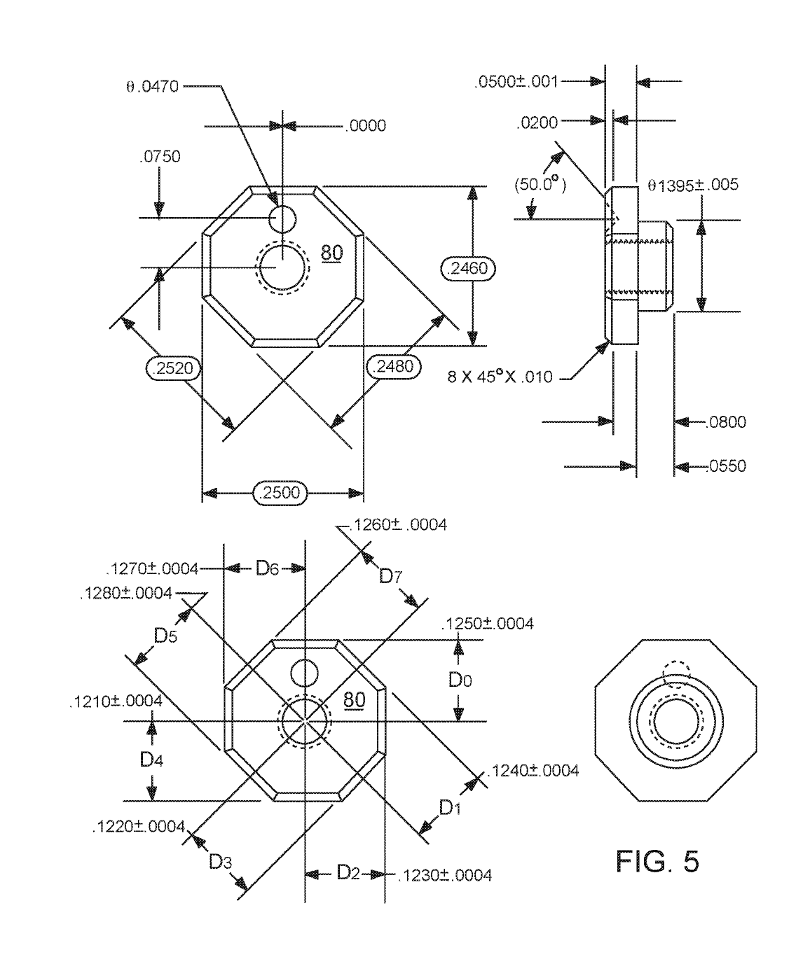

In the preferred embodiment described in FIGS. 4 and 5 the incremental diametrical difference between the adjacent surfaces is 0.0010±0004 inches. Thus, nominally:

D₀=0.1250±0004 inches

D₁=0.1240±0004 inches

D₂=0.1230±0004 inches

D₃=0.1220±0004 inches

D₄=0.1210±0004 inches

D₅=0.1280±0004 inches

D₆=0.1270±0004 inches

D₇=0.1260±0004 inches

It will be understood that these dimensions are representative only and that they may be varied depending upon the circumstances. The actual incremental measurement for D₀, D₁, D₂ and so on may be varied according to the requirements of the particular tool in which the lockface head 72 is being used. Moreover, there is no need for the incremental measurement to be the same from one surface to the next. Nonetheless, in the illustrated embodiment the actual increment in each step (i.e., D₀, D₁, D₂, etc.) is preferably about 0.001 inch. In this embodiment, therefore, there is a difference of 0.007 inch between diameter D₇ on the one hand, and diameter D₄ on the other hand. As detailed below, this incrementally increasing diameter of the lockface head 72 allows for adjustment of the lockup position of liner lock mechanism 40 in the assembled knife.

A reference notch 100 may be formed in one of the surfaces such as surface 90, which is the surface of the lockface head 72 that represents roughly the middle diametrical distance (D₀) between the minimal distance defined by D₄ and the maximal diametrical distance defined by D₅. As detailed below, reference notch 100 functions as a reference point or indicia that may be used used when adjusting the lockup position of the liner lock mechanism 40.

Each of the surfaces 90 through 97 defines a flattened face that has a chamfered edge. With specific reference to FIG. 4, the chamfered edges are identified with reference numbers that correspond to the reference numbers assigned to the surface and the subscript “C”. Thus:
90_{c}
91_{c}
92_{c}
93_{c}
94_{c}
95_{c}
96_{c}
97_{c}

In the assembled knife 10 the portion of the lockface head 72 that makes contact with the surface 32 of face 30 on the tang of the blade when the blade is locked open by the liner locking mechanism is the edge 35 defined by the intersection of the flattened face and the chamfered edge on the pertinent surface. It will be appreciated, however, that the chamfered edge is optional and that the surfaces of the lockface head may be planar. In that case the lockup surface would be the surface of the lockface head that makes contact with the facing surface of the tang of the blade. Moreover, the edge 35 could be defined by a bevel rather than a chamfer.

In operation, when blade 14 is in the closed position the liner lock mechanism 40 (which may incorporate a ball detent 102 in known manners) is biased outwardly by contact between the blade and the spring arm 52, so the spring arm is urged away from the blade slot. Because the spring arm 52 is always pushing inwardly toward the blade slot, the spring arm pushes against the blade and this retains the blade in the slot in the closed position. To open the blade it is rotated from closed toward open (using the blade flipper 28 and/or the thumb lug 24). As best illustrated in the close up drawing of FIGS. 3 and 3A, when the blade has rotated to the point where the tang face 30 clears the free end 54 of spring arm 52 the spring arm snaps inwardly according to its pre-biased spring loading and quickly is positioned behind the tang, locking the blade open. When the blade is locked as shown in FIG. 3A the edge 35 is in contact with surface 32 along a line of surface contact 33—the line of contact extends transverse to the rotational axis of lockface head 72. Simultaneously the thumb lug 34 abuts the notch 36 to stop rotation of the blade in the open direction. As noted above and as may be seen in FIG. 3A, the portion of lockface head 72 that actually engages the surface 32 on the tang of the blade when the blade is open is the edge 35 that is defined at the intersection of the flattened face and the chamfered edge on the pertinent surface. For example, if lockface head 72 is positioned on spring arm 52 in the orientation shown in FIG. 2, then the edge 33 that contacts surface 32 of the tang would be 90_{c}. Herein, that edge is referred to at times as the locking surface and as noted the locking surface is a line of contact between the edge 35 of lockface head 72 and the surface 32 of tang face 30—the line of contact is normal to the rotation axis of the lockface head 72.

Rotation of lockface head 72 relative to spring arm 52 is effective to vary the distance between the center of the lockface head and the edge of the lockface head that engages the blade in the open and locked position. Accordingly, the lockface head 72 according to the present invention is operable to change the lockup position of the blade; this is effective as noted above for accommodating variances in manufacturing and wear and the like due to repeated opening and closing cycles. By way of further explanation, the abutting relationship between thumb lug 34 and notch 36 generally does not change over time and over repeated opening and closing cycles because there is relatively little wear between the thumb lug and the notch. However, wear does occur between the lockface head 72 and surface 32 of tang 30 over time and over repeated opening, locking and closing cycles. In this example, and wear occurs there may be a need to adjust the lockup position to account for the wear. This is done by rotating the lockface head so that a selected surface of the lockface head (e.g., surfaces 90-97) that has a greater diameter relative to the previous lockup surface defines the new lockup surface.

As noted, when lockface head 72 is attached to the spring arm 52 in the normal operating position shown in, for example, FIG. 1, the lockface head cannot be rotated relative to the spring arm in view of the attachment of the lockface head to the spring arm with screw 76. In the drawing of FIG. 2, surface 94 of lockface head 72 is facing wall 82 of the cavity 74, and the opposite surface of lockface head 72—that is, surface 90 is facing the tang of the blade 14. Typically, when a knife 10 is first assembled the lockface head will be rotated such that the surface 90, which is associated with reference notch 100, faces the tang of blade 14.

In order to adjust the lockup position, screw 76 is loosened so that the lockface head may be rotated. The lockface head is rotated so that a different surface—one that defines a different distance from the centerline to the locking edge—is oriented toward the tang of the blade.

Knife 10 is initially assembled with lockface head 72 oriented on spring arm such that reference notch 100—that is, surface 90—defines the locking surface when the blade 14 is in the open position. The lockup position is checked and ideally there should be no movement of the blade relative to the handle. In other words, the lockup should be highly secure. If there is some play between the blade and the handle, screw 76 is loosened and the lockface head 72 is axially rotated so that a different surface of the lockface head defines the locking surface. For example, by rotating lockface head such that surface 94 defines the locking surface when blade 14 is in the open position, the lockup positon of the engagement between the locking surface of lockface head 72 and the blade will be varied (since, as noted above, diameter D₀ is greater than diameter D₄. The lockup position of blade 14 may in this way be adjusted to the desired point. This adjustment will be done during initial assembly of knife 10, and is useful as the parts of the knife wear from normal operation during the life of the knife.

As noted above, the incremental distance from one surface of the lockface head to the next may be adjusted according to the needs and manufacturing tolerances of the tool with which the adjustment mechanism is being used. In the embodiment illustrated herein, as noted above, the diametrical distance varies by 0.001 inch with each successive surface (i.e., from surface 90 to surface 91 and so on). With a lockface head having these dimensions, the total adjustment afforded by the mechanism is 0.007 inch, which is adequate adjustment in many manufacturing instances.

Those of ordinary skill in the art will readily appreciate that the multi-faced lockface head described herein may be used with any knife that utilizes a liner locking mechanism. Further, the material used to fabricate the lockface head and/or the surface 32 of blade 14 that is engaged by the lockface head may be chosen according to desired wear characteristics. As another modification, the lockface head illustrated and described herein is octagonal in shape—there is no reason why a lockface head having a greater or lesser number of surfaces could not be used with equal effectiveness.

While the present invention has been described in terms of preferred and illustrated embodiments, it will be appreciated by those of ordinary skill that the spirit and scope of the invention is not limited to those embodiments, but extend to the various modifications and equivalents as defined in the appended claims.

1. Apparatus for adjusting the lockup position of an implement of a folding tool that utilizes a liner lock defined by a spring arm, comprising:
a lock member attached to the spring arm at a free end thereof and rotatable about a rotation axis, said lock member having plural outer faces and wherein the diameter of the lock member from the rotation axis to one of said plural outer faces is different from the diameter of the lock member from the rotation axis to a second of said plural outer faces.

2. The apparatus according to claim 1 in which the diameter of the lock member from the rotation axis to any one of said plural outer faces is different from the diameter of the lock member from the rotation axis to any other of said plural outer faces.

3. The apparatus according to claim 2 in which each of the plural outer faces defines a locking surface that has a longitudinal axis that extends transverse to the rotation axis.

4. The apparatus according to claim 3 wherein each locking surface on each outer face is defined by an edge defined by a chamfer formed on the outer face.

5. The apparatus according to claim 4 wherein a locking surface abuts a cooperative surface on a tang portion of the implement of the folding tool to prevent movement of the implement from an open position to a closed position

6. The apparatus according to claim 5 in which the locking surface abuts the cooperative surface on the tang portion along an elongate line of contact between the edge on the outer face and the cooperative surface.

7. The apparatus according to claim 6 in which the elongate line of contact extends transverse to the rotation axis.

8. The apparatus according to claim 1 in which a cavity is formed in the free end of the spring arm and the lock member is attached to the spring arm in the cavity.

9. The apparatus according to claim 8 in which the lock member has a planar outer surface and the spring arm has a planar surface, and wherein the planar outer surface of the lock member and the planar surface of the spring arm are coplanar.

10. A method of adjusting the lockup position of an implement in a folding tool having the implement rotatably connected to a handle and capable of rotation in a path from a closed position to an open and locked position, the folding tool including a liner lock defined by a spring arm having a free end that engages a tang of the implement, the method comprising the steps of:
(a) attaching a lock head to a free end of the spring arm so that the lock head is rotatable around a lock head axis, the lock head having plural outer surfaces and wherein the diameter of the lock head from the lock head axis to any one of said plural outer surfaces is different from the diameter of the lock head from the lock head axis to any other of said plural outer surfaces; and
(b) adjusting the lockup position of the implement by rotating the lock head about the lock head axis until the desired lockup position is achieved and a desired one of the plural outer surfaces on the lock head is oriented such that the desired one of the plural outer surfaces abuts the tang of the implement when the implement is in the open and locked position.

11. The method according to claim 10 wherein one of said plural outer surfaces of said lock head includes reference indicia associated with the said one plural outer surface that differentiates said one outer surface from all other outer surfaces, and including the step of rotating the lock head about the lock head axis is preceded by a step of orienting the lock head surface having said reference indicia so that the outer surface of said lock head that includes the reference indicia abuts the tang of the implement.

12. The method according to claim 11 further including a step of fixing the rotational position of the lock head relative to the spring arm when a desired orientation between the lock head and the implement is achieved.

13. The method according to claim 12 wherein the step of fixing the rotational position of the lock head includes the step of preventing further rotation of the lock head relative to the spring arm.

14. The method according to claim 10 including the step of changing the lockup position of the implement after an initial lockup position has been set and after there has been wear between the desired one of the plural outer surfaces and the tang of the implement caused by repeated movement of the implement between closed and open and locked positions.

15. A method of adjusting the lockup position of a liner locking mechanism in which the forward end of a spring arm engages a tang of an implement in a folding tool to lock the implement in an open position, comprising the steps of:
a. connecting a lockface head to a forward end of a spring arm, said lockface head having plural surfaces around a periphery thereof and wherein the distance from an axial center of said lock member head to any one of the plural outer surfaces is different from the distance from the axial center to all other of the plural outer surfaces;
b. moving the implement to the open position; and
c. rotating the lockface head so that a select one of said plural outer surfaces engages the implement tang.

16. An adjustment mechanism for a folding tool that utilizes a liner lock, comprising:
a lock member attached to a forward end of a spring arm that, the lock member having plural surfaces around a periphery thereof and wherein the distance from an axial center of said lock member head to any one of the plural outer surfaces is different from the distance from the axial center to all other of the plural outer surfaces.

17. The adjustment mechanism according to claim 16 in which each of the plural outer surfaces defines a locking surface that has a longitudinal axis that extends transverse to the axis that defines the axial center of the lock member.

18. The adjustment mechanism according to claim 17 wherein each locking surface is defined by an edge defined by a chamfer formed on the outer surfaces.

19. The adjustment mechanism according to claim 16 including a blade stop for stopping rotation of the blade in the open position.

20. The adjustment mechanism according to claim 19 wherein the blade stop is defined by a stud on the implement and a cooperative notch formed on the blade.
